(19) United States
(12) Patent Application Publication
(10) Pub. No.: US 2026/0328957 A1
(43) Pub. Date: Oct. 22, 2026

(54) PRESSURE AND STRESS DRIVEN INDUCED SEISMICITY HISTORY MATCHING AND FORECASTING

(71) Applicant: Chevron U.S.A. Inc., San Ramon, CA (US)

(72) Inventors: Zijun FANG, Sugar Land, TX (US); Yunhui TAN, Houston, TX (US); Margaretha Catharina Maria RIJKEN, Houston, TX (US); Krittanon SIRORATTANAKUL, Houston, TX (US)

(73) Assignee: Chevron U.S.A. Inc., San Ramon, CA (US)

(21) Appl. No.: 19/099,608

(22) PCT Filed: Jul. 28, 2023
(86) PCT No.: PCT/US2023/071283

§ 371 Date: Jan. 29, 2025

Related U.S. Application Data
(60) Provisional application No. 63/369,918, filed on Jul. 29, 2022.
(60) Provisional application No. 63/458,983, filed on Apr. 13, 2023.

(51) Int. Cl. G01V 1/28

(52) U.S. Cl. CPC G01V 1/288; G01V 1/282; G01V 2210/642

(57) ABSTRACT

A method is described for pressure and stress driven induced seismicity history matching and forecasting. The method includes determining an estimated probability of potential future induced seismic events of different magnitudes based on the forecasted potential future event occurrence rate, the Gutenberg-Richter b value, and the uncertainty range for the Gutenberg-Richter b value. The method further may include generating a representation of the estimated probability of potential future induced seismic events of different magnitudes and displaying the representation in a graphical user interface. The method may be executed by a computer system.

### CROSS-REFERENCE TO RELATED APPLICATIONS

This application claims benefit of U.S. Provisional Application No. 63/369,918, filed Jul. 29, 2022, which is hereby incorporated by reference in its entirety. This application claims benefit of U.S. Provisional Application No. 63/458,983, filed Apr. 13, 2023, which is hereby incorporated by reference in its entirety.

### STATEMENT REGARDING FEDERALLY SPONSORED RESEARCH OR DEVELOPMENT

Not applicable.

### TECHNICAL FIELD

The disclosed embodiments relate generally to techniques for induced seismicity forecasting.

### BACKGROUND

“Induced seismicity” refers to seismicity associated with several industrial practices such as impoundment of water behind a dam, mining, and other activities. Governmental bodies impose regulations or guidance intended to reduce risk from induced seismicity. Therefore, there is a need for induced seismicity forecasting for a given operational plan to assist with managing risk from managing induced seismicity.

### SUMMARY

In accordance with some embodiments, a method of induced seismicity forecasting is disclosed. The method may include (a) obtaining a dataset of induced seismic events, reservoir properties, fault geometry, a measured pressure dataset, a historical operational plan, and a future operation plan for a subsurface volume of interest comprising at least one fault; (b) determining a magnitude of completeness for the subsurface volume of interest from the dataset obtained in the step (a), wherein the magnitude of completeness is a location dependent magnitude of completeness or a constant magnitude of completeness; (c) filtering the dataset of induced seismic events using the determined location dependent magnitude of completeness from the step (b) or the determined constant magnitude of completeness from the step (b) to form a processed dataset of induced seismic events; (d) determining a Gutenberg-Richter b-value and an uncertainty range for the Gutenberg-Richter b value for the subsurface volume of interest for the dataset of induced seismic events from the step (a); (e) building a geomechanical model of the subsurface volume of interest by history matching the measured pressure dataset from the step (a) to determine pressure for each fault and Coulomb stress change for each fault, wherein the Coulomb stress change of each fault is based on the corresponding determined pressure of each fault, and wherein building the geomechanical model further includes utilizing the obtained reservoir properties from the step (a) and the fault geometry from the step (a); (f) history matching a historical event occurrence rate for the processed dataset of induced seismic events from the step (c) using the historical operational plan from the step (a) and a correlation between the historical event occurrence rate and the Coulomb stress change of each fault from the step (e) to determine best fitting parameters; (g) forecasting a potential future event occurrence rate for induced seismic events above the location dependent magnitude of completeness or the constant magnitude of completeness from the step (b) based on future operational plan from the step (a) using the best fitting parameters from the step (f); (h) for cases where the magnitude of completeness is location dependent, building a location penalty matrix to describe location dependent detection bias using the processed dataset of induced seismic events from the step (c) and the Gutenberg-Richter b value from the step (d), and updating the potential future event occurrence rate to include events larger than the smallest magnitude of completeness using the location penalty matrix; and (i) determining an estimated probability of potential future induced seismic events of different magnitudes based on the forecasted potential future event occurrence rate from the step (h), the Gutenberg-Richter b value from the step (d), and the uncertainty range for the Gutenberg-Richter b value from step (d). The method may further generate a representation of the estimated occurrence probability of potential future induced seismic events of different magnitudes and display the representation in a graphical user interface. In some embodiments, the uncertainty range for the Gutenberg-Richter b-value is determined using a Markov Chain Monte Carlo (MCMC) scheme or a bootstrap approach. In some embodiments, the history matching may be performed based on the critical Coulomb stress threshold required to drive a fault toward instability, the Coulomb stress change, the time required to return to steady-state, the time at which Coulomb stress exceeded critical threshold, the time t and time increment Δt, the seismicity rate at time t, the background seismicity rate, the rate and state dependent friction parameter describing amount of friction change due to slip velocity change, the initial effective normal stress at t=0, and the background shear stressing rate. In some embodiments, the estimated occurrence probability of potential future induced seismic events of different magnitudes is determined based on Poisson likelihood.

In another aspect of the present invention, to address the aforementioned challenges, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned challenges, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system of induced seismicity forecasting.

FIG. 2 illustrates an example method of induced seismicity forecasting.

FIGS. 3A-3Q illustrates a synthetic example of induced seismicity forecasting.

Like reference numerals refer to corresponding parts throughout the drawings.

### DETAILED DESCRIPTION OF EMBODIMENTS

Fault stability analysis is often utilized for evaluating risk from induced seismicity. Fault stability analysis provides a rough estimate of the threshold pressure that a fault could become unstable (i.e., seismogenic), but it does not quantitatively correlate changes in stress and pressure to levels of seismicity because of the intrinsic limitations of the Mohr-Coulomb friction law utilized in this analysis, nor does it capture the time delay require for a fault to transition to become unstable.

In another approach, a more sophisticated type of fault friction was created, that through lab experiments, was later proven to be effective in explaining many types of observed characteristics of induced seismic events. This approach captures the time delay required for a fault to transition to become unstable and has been widely accepted for describing stick-slip frictional behaviors, i.e., how an induced seismic event initiates, propagates and arrests, and known as the “rate and state dependent friction”.

Yet another approach derived a quantitative correlation between changes in Coulomb stress and the rate of seismicity with respect to background level, which was widely used in academia to explain and model increased levels of seismicity. Afterwards, another approach applied this correlation to model injection induced seismicity and provided a sound explanation to a widely observed but counter-intuitive phenomenon that abrupt stop in injection is followed by sudden increase in seismicity. More recently, multiple academic groups have employed this correlation to model induced seismic sequences due to wastewater injection and due to gas extraction. These studies are the first attempts to use this correlation to model observed induced seismicity history.

However, these approaches were more research type studies targeted to explain observed phenomena without a systematic approach in implementing field operations in a manner to manage or reduce induced seismicity levels. These approaches were also generic types of studies that did not account for real world complexity for evaluating risk from induced seismicity. For example, the approaches did not account for injection into multiple formations at different depths, fault initial conditions, seismic sensor network detection bias, and/or no extrapolation to regional faults with no seismicity history. The parameters space explored in those studies was also limited.

Described below are methods, systems, and computer readable storage media that provide a manner of induced seismicity forecasting. These embodiments may be of particular use for induced seismicity forecasting in the energy industry. For example, these embodiments may be of particular use for induced seismicity forecasting in the following operations: injection of a large volume of fluid during an injection period, removal of a large volume of fluid during a removal period, or any combination thereof. For example, these embodiments may be of use for induced seismicity forecasting in operations related to disposal well injections, gas storage (including greenhouse gas storage), and hydrocarbon production processes such as hydraulic fracturing, but this is not an exhaustive list. The fluid may be in a liquid phase only in some embodiments. The fluid may be in a gaseous phase only in some embodiments. The fluid may be in a liquid phase and a gaseous phase in some embodiments. The fluid may be practically any fluid, such as, but not limited to, water (e.g., effluent water), fracturing fluid, carbon dioxide, and/or other types of fluid.

The embodiments herein provide physics-based induced seismicity forecasts of potential future seismicity levels by leveraging the observed history of induced seismicity. The capability to provide quantitative assessment of future seismicity levels based on different operation scenarios facilitates adjustment and/or management of field operations designed to manage or reduce risk from induced seismicity. For example, the embodiments may be utilized to adjust injection rates, adjust production rates, decide whether to shut-in wells, design of future operations, and the like. Indeed, the embodiments may be utilized to inform decisions for purchasing materials, operating safely, and successfully completing projects. Other decisions that may be made may include, but are not limited to, budgetary planning, obtaining mineral and lease rights, signing well commitments, permitting rig locations, designing well paths and drilling strategy, preventing subsurface integrity issues by planning proper casing and cementation strategies, selecting and purchasing appropriate completion equipment, injection equipment, and production equipment.

The term “injection period” refers to injection of the fluid for an injection period lasting a plurality of days, such as more than 30 days (e.g., more than 40 days, more than 50 days, more than 60 days, more than 70 days, more than 80 days, more than 90 days, more than 100 days, more than 110 days, more than 120 days, more than 150 days, more than 180 days, more than 200 days, more than 250 days, more than 300 days, more than 350 days, more than 1 year, more than 2 years, more than 3 years, more than 4 years, more than 5 years, more than 10 years, more than 15 years, more than 20 years, or more than 25 years). The injection period may be more than 30 days to 30 years in one embodiment, more than 30 days to 20 years in another embodiment, more than 30 days to 10 years in another embodiment, more than 30 days to 5 years in another embodiment, or more than 30 days to 1 year in another embodiment. The injection of the fluid may be continuous (e.g., occur on every day during the injection period) or discontinuous (e.g., does not occur on every day during the injection period).

As injection generally occurs during an injection period of more than 30 days though, the volume of fluid that is injected during the injection period is large. For example, the term “injection of a large volume of fluid during an injection period” may refer to injecting at least 10,000 bbl/day (e.g., at least 11,000 bbl/day, at least 12,000 bbl/day, at least 13,000 bbl/day, at least 14,000 bbl/day, at least 15,000 bbl/day, at least 16,000 bbl/day, at least 17,000 bbl/day, at least 18,000 bbl/day, at least 19,000 bbl/day, or at least 20,000 bbl/day) for the entire injection period or substantially the entire injection period. In one embodiment, “injection of a large volume of fluid during an injection period” may include injection of at least 10,000 bbl/day during an injection period of more than 30 days. Of note, the values provided herein are non-limiting as there is no theoretical minimum number of bbl/day to be injected, and those of ordinary skill in the art may utilize embodiments consistent with the instant disclosure in a variety of circumstances.

Similarly, the term “production period” refers to production (also known as extraction) of the fluid for a production period lasting a plurality of days, such as more than 30 days (e.g., more than 40 days, more than 50 days, more than 60 days, more than 70 days, more than 80 days, more than 90 days, more than 100 days, more than 110 days, more than 120 days, more than 150 days, more than 180 days, more than 200 days, more than 250 days, more than 300 days, more than 350 days, more than 1 year, more than 2 years, more than 3 years, more than 4 years, more than 5 years, more than 10 years, more than 15 years, more than 20 years, or more than 25 years). The production period may be more than 30 days to 30 years in one embodiment, more than 30 days to 20 years in another embodiment, more than 30 days to 10 years in another embodiment, more than 30 days to 5 years in another embodiment, or more than 30 days to 1 year in another embodiment. The production of the fluid may be continuous (e.g., occur on every day during the production period) or discontinuous (e.g., does not occur on every day during the production period).

As production generally occurs during a production period of more than 30 days though, the volume of fluid that is removed during the production period is large. For example, the term “production of a large volume of fluid during a production period” may refer to producing at least 10,000 bbl/day (e.g., at least 11,000 bbl/day, at least 12,000 bbl/day, at least 13,000 bbl/day, at least 14,000 bbl/day, at least 15,000 bbl/day, at least 16,000 bbl/day, at least 17,000 bbl/day, at least 18,000 bbl/day, at least 19,000 bbl/day, or at least 20,000 bbl/day) for the entire production period or substantially the entire production period. In one embodiment, “production of a large volume of fluid during a production period” may include production of at least 10,000 bbl/day during a production period of more than 30 days. Of note, the values provided herein are non-limiting as there is no theoretical minimum number of bbl/day to be produced, and those of ordinary skill in the art may utilize embodiments consistent with the instant disclosure in a variety of circumstances.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

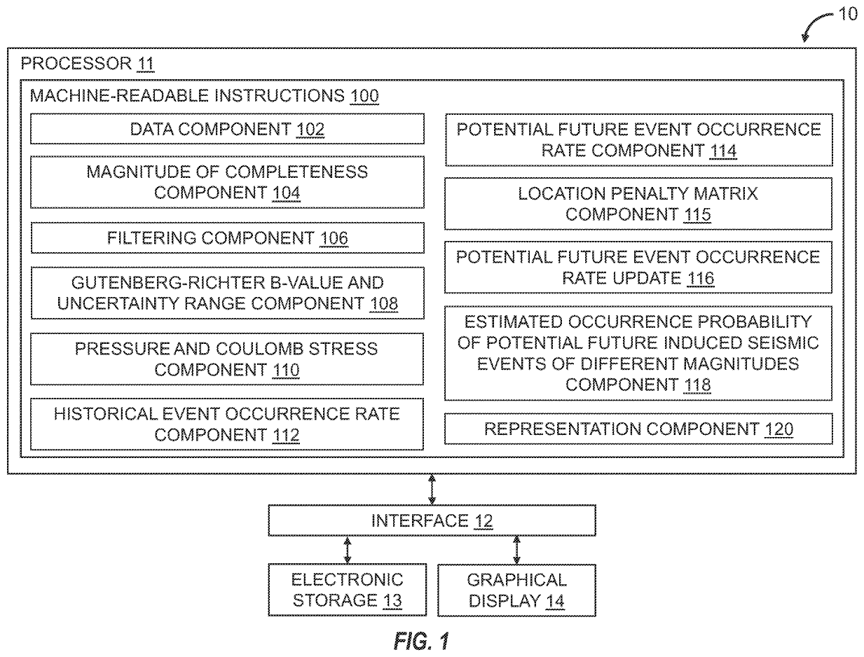

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 12, and/or other components. The processor 11 may execute a method of induced seismicity forecasting. The input includes a dataset of induced seismic events for a subsurface volume of interest. The output includes an estimated occurrence probability of potential future induced seismic events of different magnitudes.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to a dataset of induced seismic events for a subsurface volume of interest, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to the estimated occurrence probability of potential future induced seismic events of different magnitudes, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate induced seismicity forecasting. The machine-readable instructions 100 may include one or more computer program components. The machine-readable instructions 100 may include a data component 102, a magnitude of completeness component 104, a filtering component 106, a Gutenberg-Richter b value and uncertainty range component 108, a pressure and Coulomb stress component 110, a historical event occurrence rate component 112, a potential future event occurrence rate component 114, a location penalty matrix component 115, a potential future event occurrence rate update component 116, an estimated occurrence probability of potential future induced seismic events of different magnitudes component 118, a representation component 120, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the data component 102 may be configured to obtain a dataset of induced seismic events for a subsurface volume of interest comprising at least one fault, for example, from non-transient electronic storage. The dataset of induced seismic events may include pre-stack seismic data or post-stack seismic data. The dataset may include a plurality of traces recorded by at least one seismic sensor. The dataset may have undergone one or more processing steps.

Seismic sensors (also referred to as seismic receivers or simply receivers) are deployed at predetermined locations to detect seismic waves that propagate through a subterranean geological medium. Some seismic sensors are sensitive to pressure changes (e.g., hydrophones), others to particle motion (e.g., geophones), and one type of sensor or both types may be deployed. In response to the detected seismic waves, the sensors generate corresponding electrical signals, known as traces, and record them in storage media as seismic data.

The seismic data may be pre-stack seismic data or post-stack seismic data. The dataset may include a plurality of traces recorded by at least one seismic sensor (e.g., recorded by a plurality of seismic sensors). A geophone or a network of geophones, a hydrophone or a network of hydrophones, or practically any seismic sensor or network of seismic sensors may be utilized as long as it is capable of performing these functions. At least one seismic sensor may be installed in the subsurface volume of interest using conventional techniques for performing these functions. The seismic dataset that is obtained may have already been subjected to a number of seismic processing steps, such as instrument response correction, band-pass filtering, deconvolution, wavelet analysis, Fourier transform, and the like.

From which induced seismic events are detected and located. The detection may utilize picking of arrival time of seismic waves using short-time-average/long-time-average (STA/LTA) trigger. These picks may be associated with seismic phases by examining combinations of arrival times from a plurality of seismic sensors. These seismic phases along with seismic velocity profile of the subsurface obtained separately or through tomographic inversion may then be used to locate the origin time and location of induced seismic events in the subsurface. Magnitudes may be calculated using amplitudes of seismic waves or the corner frequency of the spectra of seismic waves. These examples are not meant to be limiting. Those of skill in the art will appreciate that there are a number of useful seismic processing steps that may be applied to seismic data to enhance the data or reduce noise and improve accuracy of induced seismic events origin time, location, and magnitude.

The data component 102 may be configured to obtain other data for the subsurface volume of interest, for example, from non-transient electronic storage. The other data may be reservoir properties, fault geometry, a measured pressure dataset, a historical operational plan, and/or a future operational plan for the subsurface volume of interest comprising the at least one fault. Examples of the reservoir properties may be permeability, porosity, compressibility, Elastic modulus, shear modulus, Poisson ratio, and Biot's coefficient, and the reservoir properties may be generated from lab tests or inferred from reservoir simulations. The fault geometry may include information such as fault strike, fault dip, fault length, and fault width for each fault in the subsurface volume of interest, and the fault geometry may be generated from seismic, surface mapping and earthquake focal mechanism solutions. The pressure dataset may be generated by reservoir simulation models that are matched to downhole measured pressure data. The historical operational plan may include values for the various parameters already utilized in a past operation (e.g., past injection operation) on the subsurface volume of interest, such as, but not limited to, injection rate, composition of an injection fluid, etc. The various values for the historical operational plan may have been previously selected by a user and utilized in the historical operational plan in some implementations. The future operational plan may include values for the various parameters that may be utilized in a future operation (e.g., future injection operation) on the subsurface volume of interest, such as, but not limited to, injection rate, composition of an injection fluid, etc. The various values for the future operational plan may be selected by a user in some implementations.

The magnitude of completeness component 104 may be configured to determine a magnitude of completeness, a threshold to which all events larger than this threshold are almost always detectable and locatable by the network of geophones with miniscule miss detection referred to as M_{c}, for the subsurface volume of interest. The determined magnitude of completeness may be a constant magnitude of completeness in some embodiments. The constant M_{c} may be determined by identifying the magnitude bin at which the non-cumulative events count is at maximum. A constant magnitude of completeness may correspond to a single value herein.

Alternatively, the determined magnitude of completeness may be a location dependent magnitude of completeness, referred to as M_{c}(r), in some embodiments. The location dependent magnitude of completeness accounts for the effects of the geometric spreading of seismic waves with distance to the receiver r, in which small magnitude events occurring nearby are detectable while those with same magnitude further away may be undetected leading to location dependent detection bias. The location dependent magnitude of completeness accounts for distance may be determined by binning events based on distance to the receiver r and calculate M_{c} using maximum non-cumulative events count for each bin. These bins may be overlapping or non-overlapping. The determined M_{c} between bins may be interpolated with a spline function or modeled a prior with some given analytical forms such as a logarithmic function or a 3^{rd} order polynomial. A location dependent magnitude of completeness may correspond to a plurality of values herein.

The filtering component 106 may be configured to filter the dataset of induced seismic events using the determined magnitude of completeness to form a processed dataset of induced seismic events that is deemed completed with miniscule miss detection. For instance, if a constant magnitude of completeness is utilized, a processed dataset takes all of the events above M_{c}. If a location dependent magnitude of completeness is utilized, then events below M_{c}(r) may be filtered out. Various declustering algorithms can be used to determine aftershocks productivity and to identify aftershocks that are not directly induced by subsurface operations, which may also be filtered out.

The Gutenberg-Richter b-value and uncertainty range component 108 may be configured to determine a Gutenberg-Richter b-value and an uncertainty range for the Gutenberg-Richter b-value for the subsurface volume of interest. The Gutenberg-Richter law describes the relationship between the number of seismic events and their magnitudes:

log₁₀N[mᵢ>m]=a−bm

wherein N[mᵢ>m] refers to cumulative number of seismic events with magnitudes larger than m, b refers to the Gutenberg-Richter b-value, and a is some constant related to the productivity of the seismic sequences.

The Gutenberg-Richter b-value may be determined using a maximum likelihood estimate:

$$b = \frac{{log}_{10} e}{{\sum }_{i} ( {M}_{i} - {M}_{c} ( {r}_{i} ) )}$$

wherein b refers to the Gutenberg-Richter b-value, e refers to the Euler's number which is a mathematical constant approximately equals to 2.71828, Mᵢ refers to the magnitude of events i, rᵢ refers to the distance to the receiver of events i, and M_{c} refers to magnitude of completeness at distance rᵢ. If a constant magnitude of completeness is utilized, M_{c}(rᵢ) may simply be substituted by a constant M_{c}. The uncertainty range for the Gutenberg-Richter b-value maybe determined using a Markov Chain Monte Carlo (MCMC) scheme or a bootstrap approach.

The pressure and Coulomb stress component 110 may be configured to determine pressure and Coulomb stress changes for each fault of the subsurface volume of interest. Pressure and Coulomb stress component 110 may include building a geomechanical model of the subsurface volume of interest by history matching the measured pressure dataset to determine pressure for each fault and Coulomb stress change for each fault. The geomechanical model may be a mechanical earth model (MEM) with different levels of complexity (e.g., analytical solutions, one-way couple, two-way couple) and may be generated using physical properties of the subsurface (e.g., rock properties), injection or extraction duration (e.g., operational plan), volume (e.g., operational plan), pressure, and geometry of existing fault planes (e.g., fault geometry). If the geomechanical model is built using an analytical solution or a one-way couple, then pressure may be an input that feeds into the MEM. Thus, the workflow may first need to determine pressure from a flow model for the analytical solution and/or the one-way couple. If the geomechanical model is built using a two-way couple, then pressure and MEM may be run simultaneously as a two-way couple MEM affects the pressure.

A uniform compaction poroelastic response solution may be used to track stress changes with pressure:

$$\begin{matrix}Δ {S}_{hmin} = Δ {S}_{Hmax} = α \frac{v}{1 - v} Δ P \\ Δ {S}_{v} = α Δ P\end{matrix}$$

wherein ΔP refers to fluid pore pressure change, α refers to the Biot-Willis coefficient, ΔSᵥ refers to vertical compressional stress change, v refers to Poisson's ratio, ΔS_{Hmax} refers to maximum horizontal compressional stress change, and ΔSₕₘᵢₙ refers to minimum horizontal compressional stress change.

From which shear and normal stress acting on a fault plane with strike θ and dip φ for this particular stress state takes the form as:

$$\begin{matrix}{σ}_{n} = {σ}_{xx} {n}_{x}^{2} + {σ}_{yy} {n}_{y}^{2} + {σ}_{zz} {n}_{Z}^{2} \\ {τ}_{s} = \sqrt{{( {σ}_{xx} - {σ}_{yy} )}^{2} {n}_{x}^{2} {n}_{y}^{2} + {( {σ}_{yy} - {σ}_{zz} )}^{2} {n}_{y}^{2} {n}_{Z}^{2} + {( {σ}_{zz} - {σ}_{xx} )}^{2} {n}_{Z}^{2} {n}_{x}^{2}}\end{matrix}$$

wherein τₛ refers to shear stress acting on a fault plane, σₙ refers to normal stress acting on a fault plane, σᵢⱼ refers to a component of ij where i∈{x, y, z} and j∈{x, y, z} of the stress tensor, and nᵢ refers to the component i∈{x, y, z} of the following unit vector \hat{n} which is normal to the fault plane:

\hat{n}=[nₓ,n_{y},n_{z}]=[cos θ sin φ,−sin θ sin φ,cos φ]

From which Coulomb stress change is defined as:

ΔS=Δτ+μ(Δσ−ΔP)

wherein ΔS refers to Coulomb stress change, Δτ refers to shear stress change, Δσ refers to normal stress change, ΔP refers to fluid pore pressure change, ΔS refers to Coulomb stress change, and μ refers to static friction coefficient commonly taken to be 0.6.

$$Δ {S}_{c} = {σ}_{0} - \frac{{τ}_{0}}{μ}$$

From which the critical Coulomb stress threshold required for a fault plane to slip is defined as:

$$Δ {S}_{c} = {σ}_{0} - \frac{{τ}_{0}}{μ}$$

wherein ΔS_{c} refers to critical Coulomb stress threshold, σ₀ refers to initial effective normal stress acting on a fault plane, τ₀ refers to initial shear stress acting on a fault plane, and μ refers to static friction coefficient commonly taken to be 0.6.

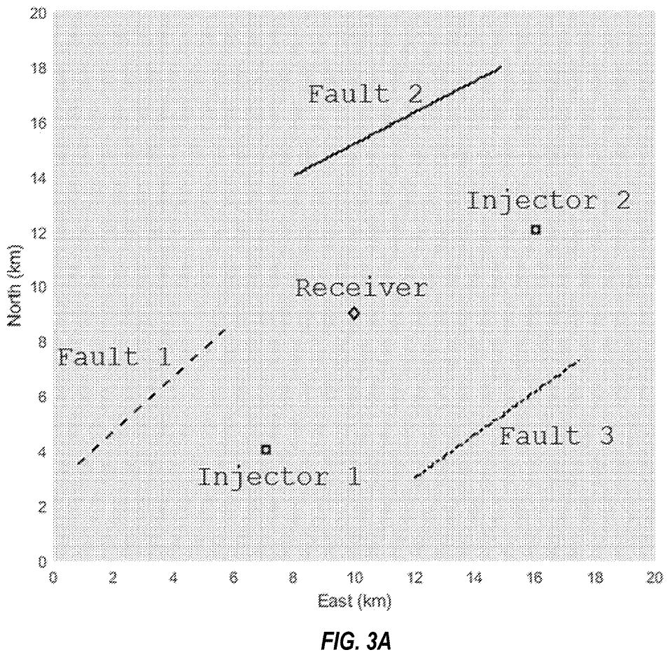

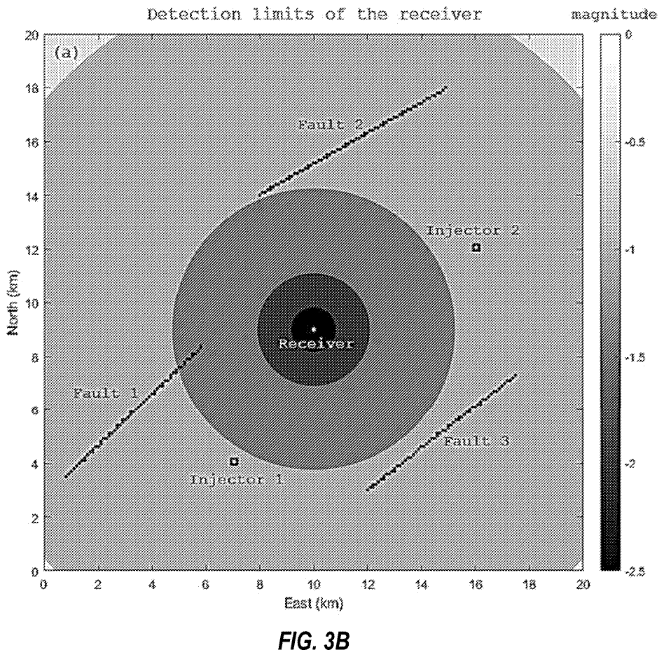

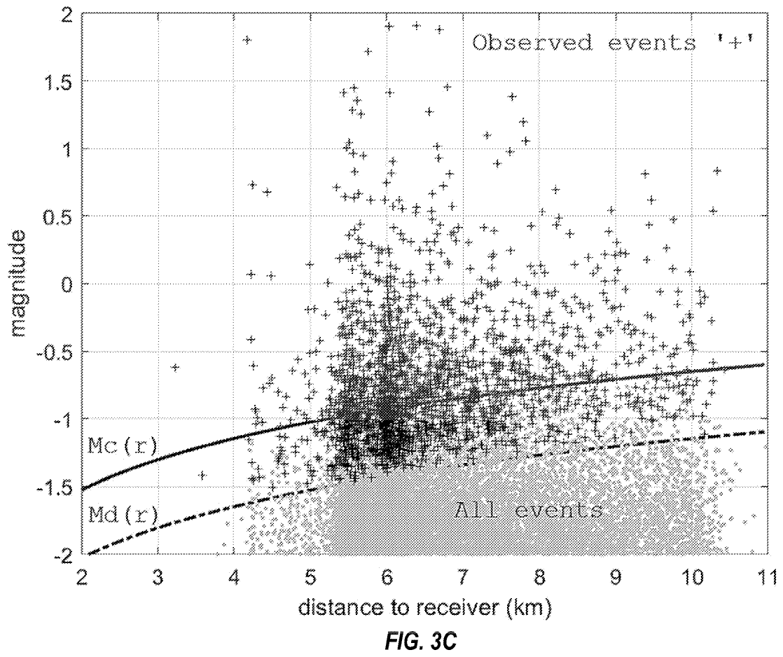

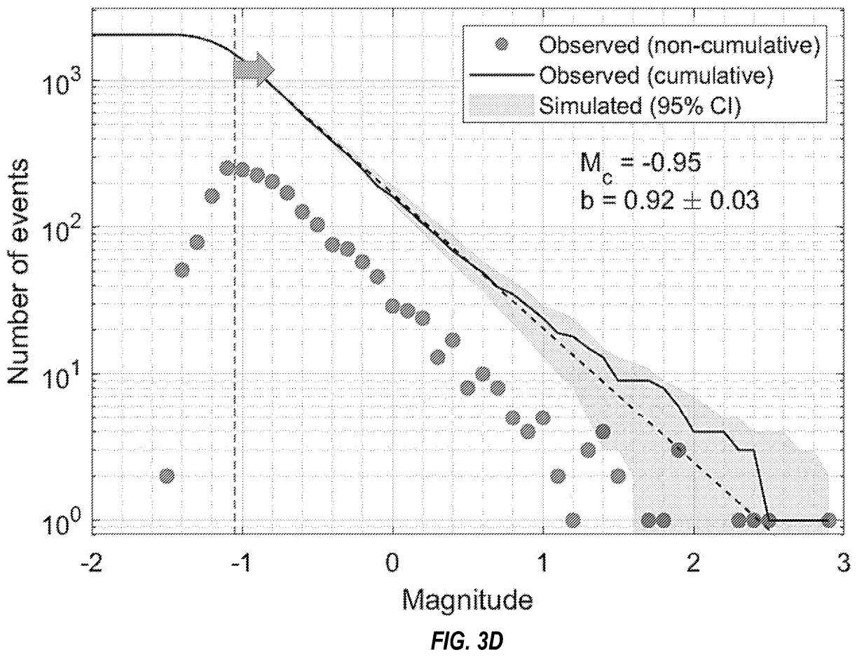

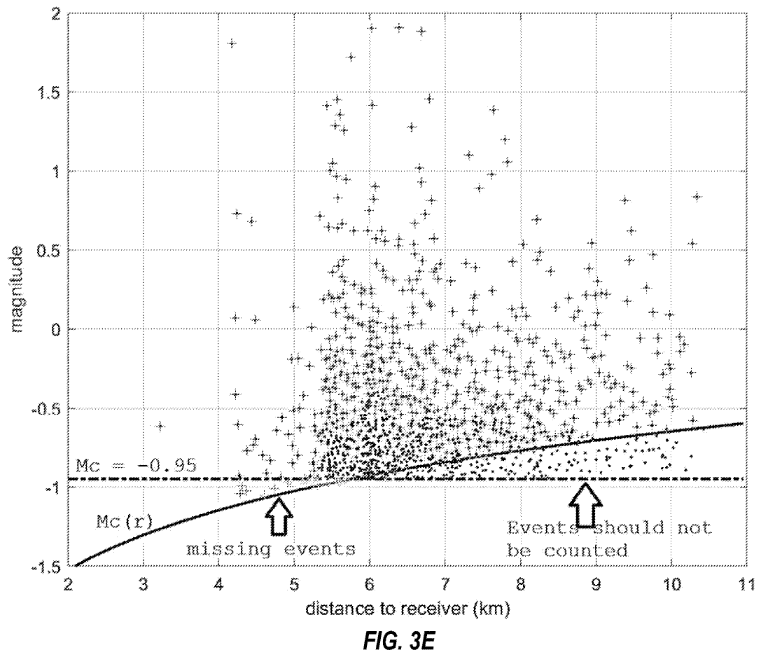

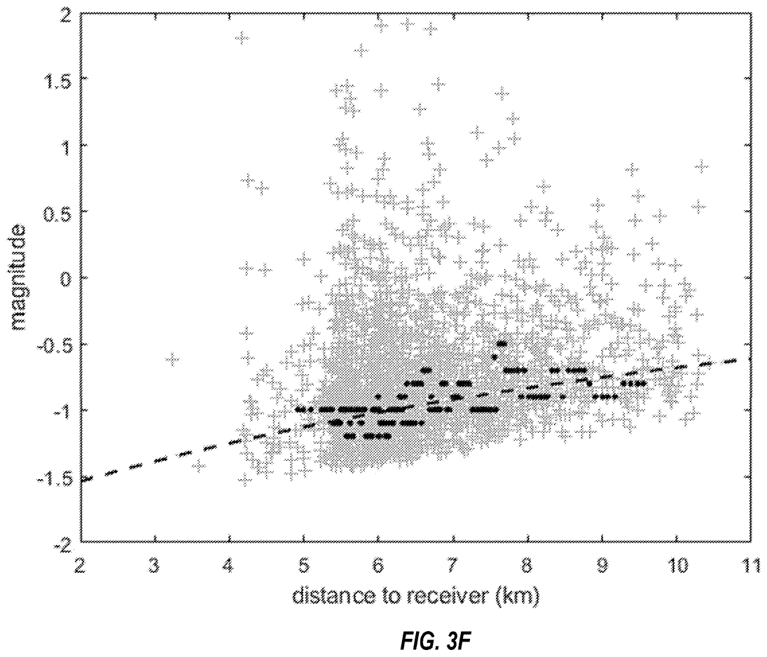

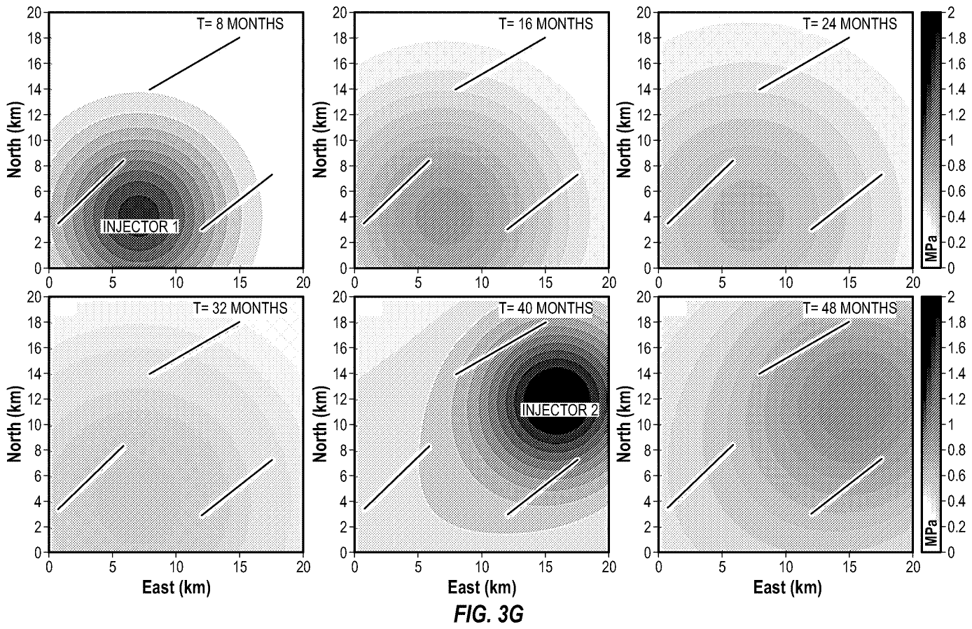

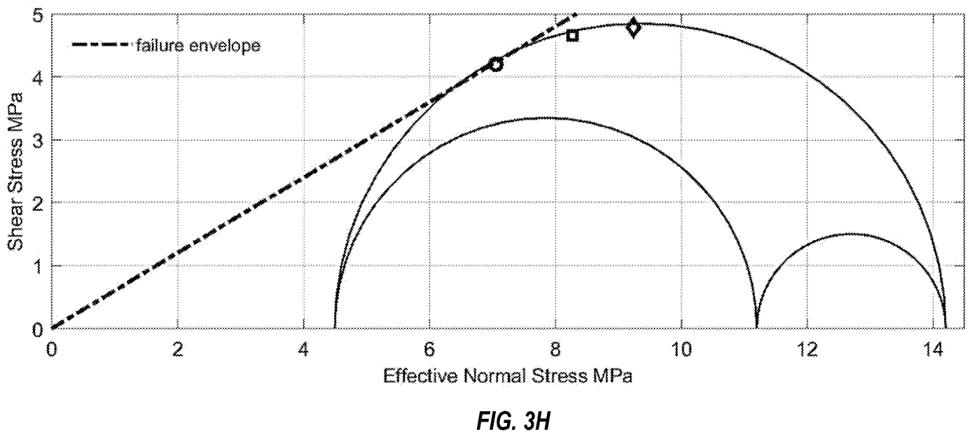

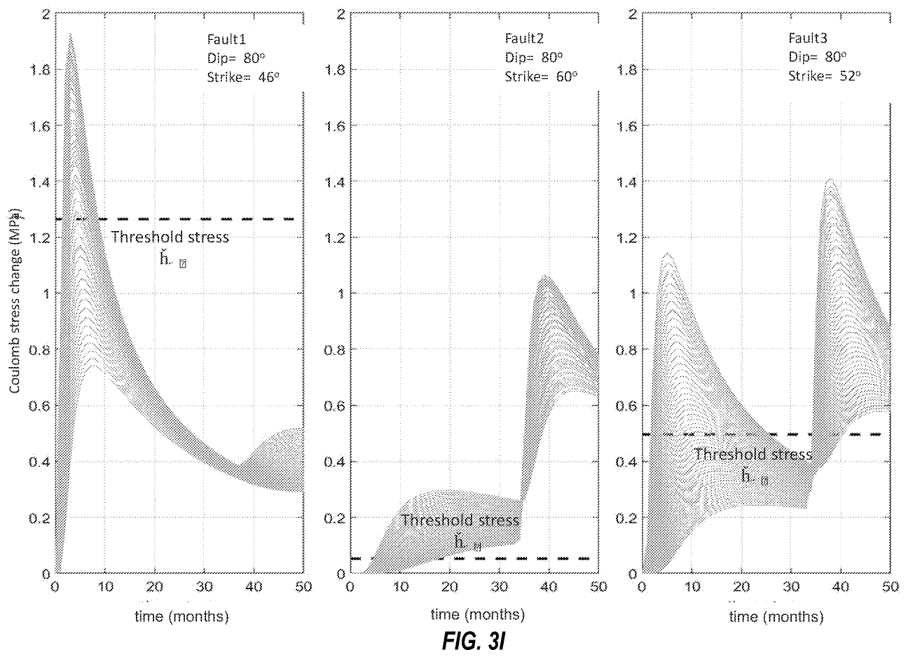

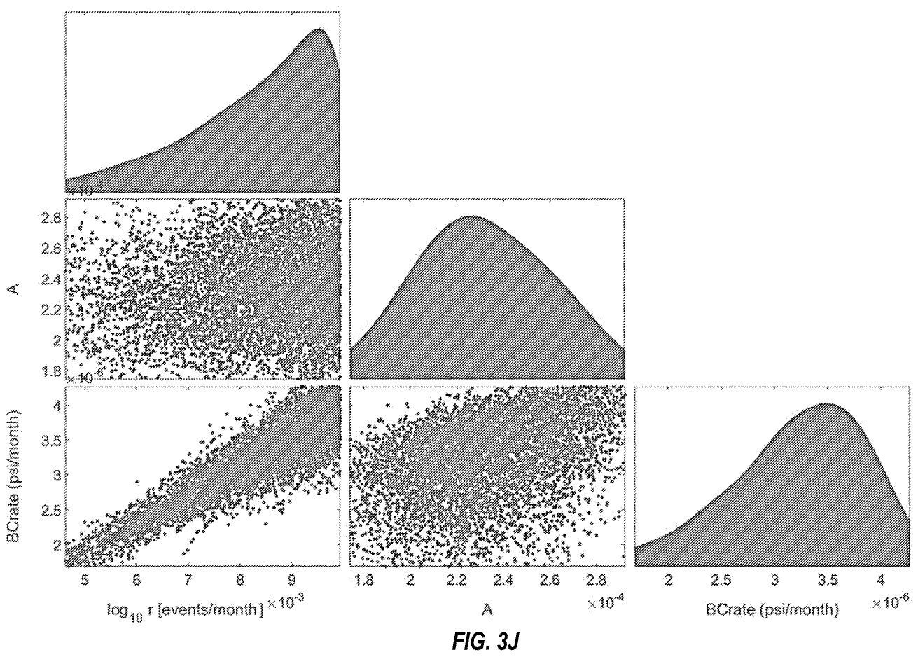

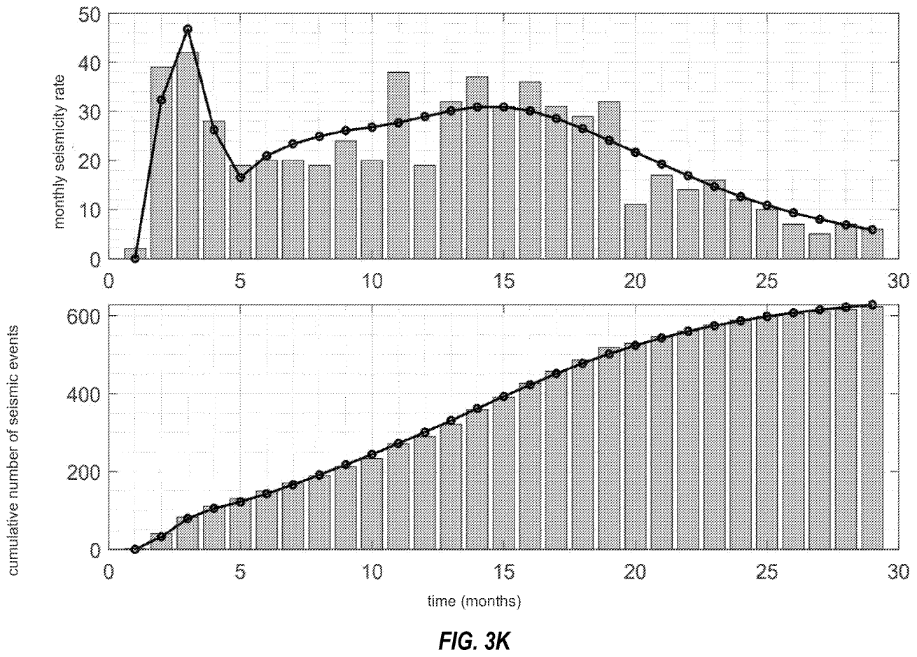

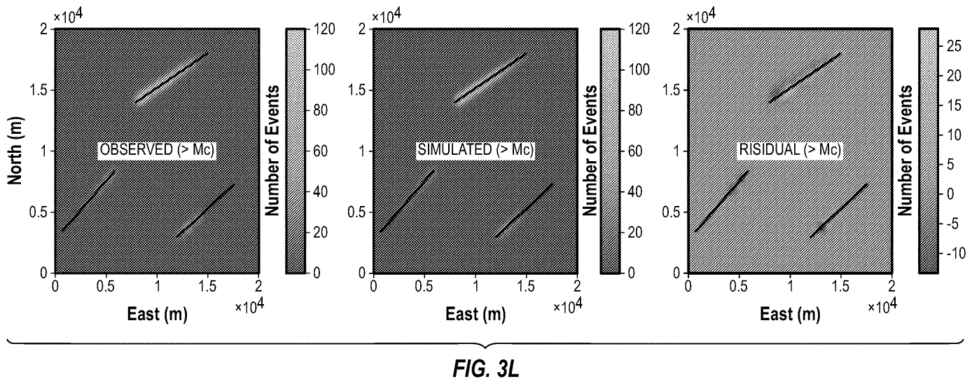

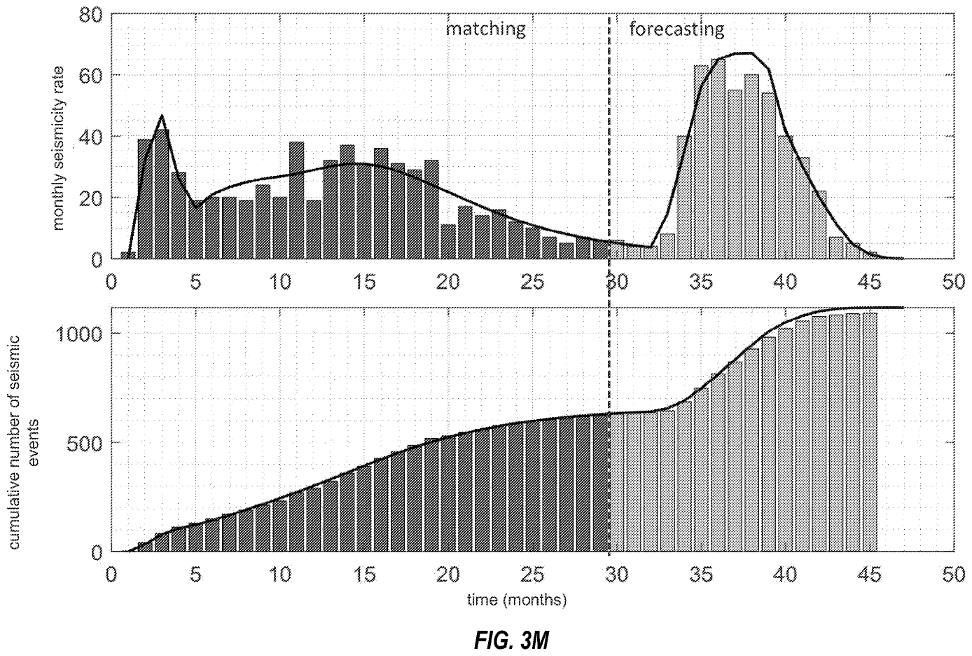

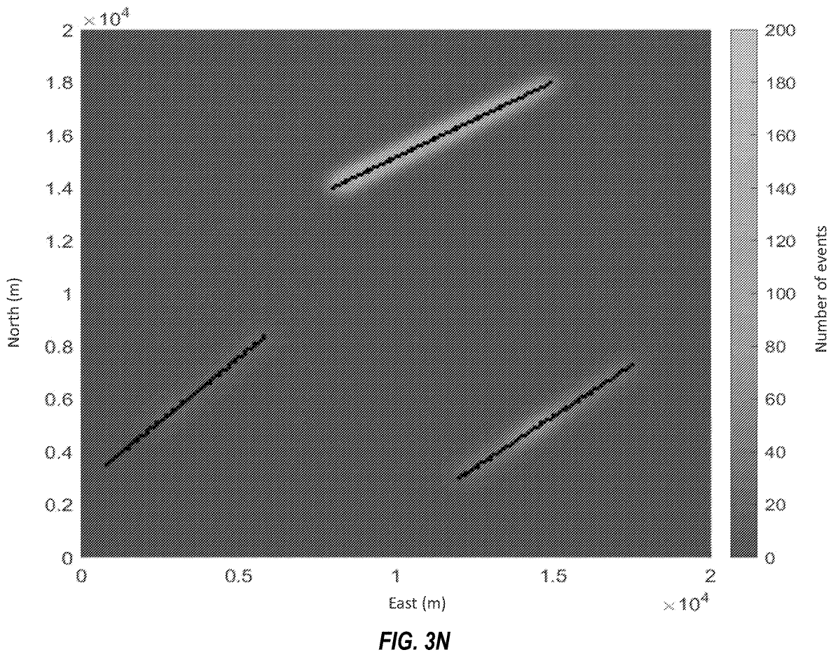

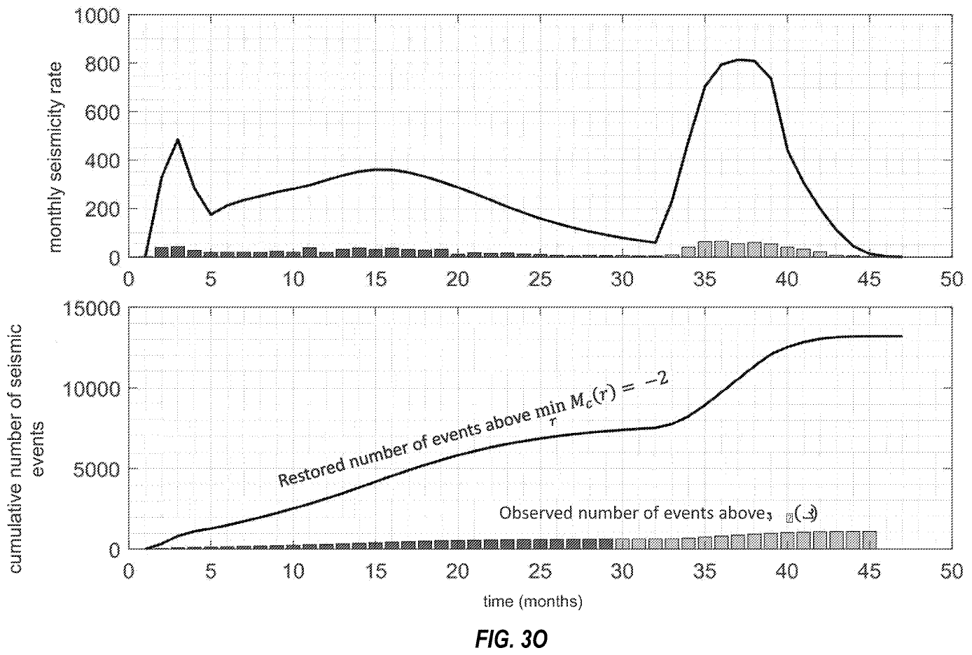

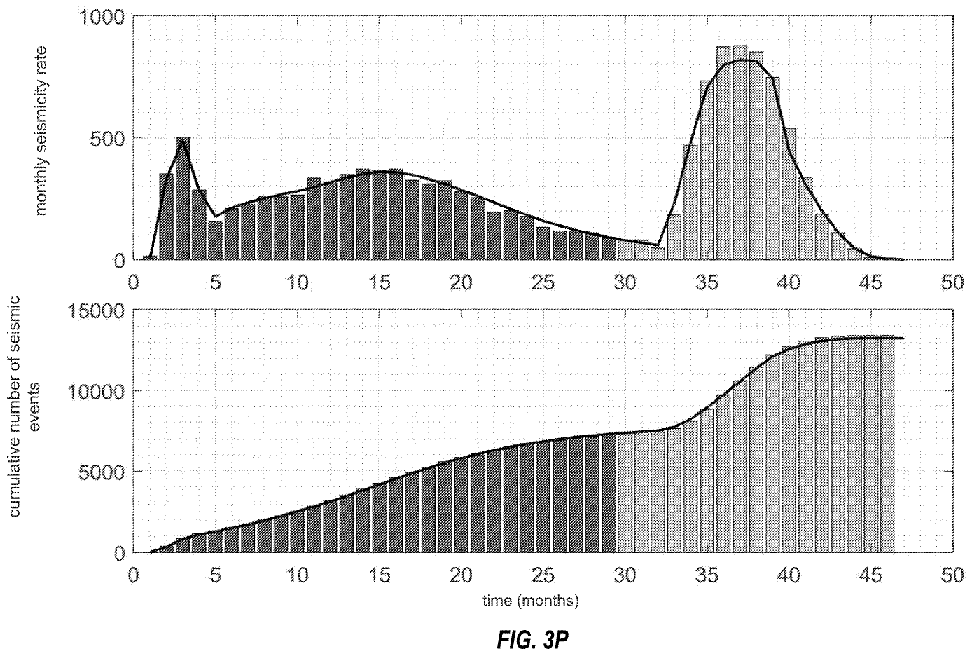

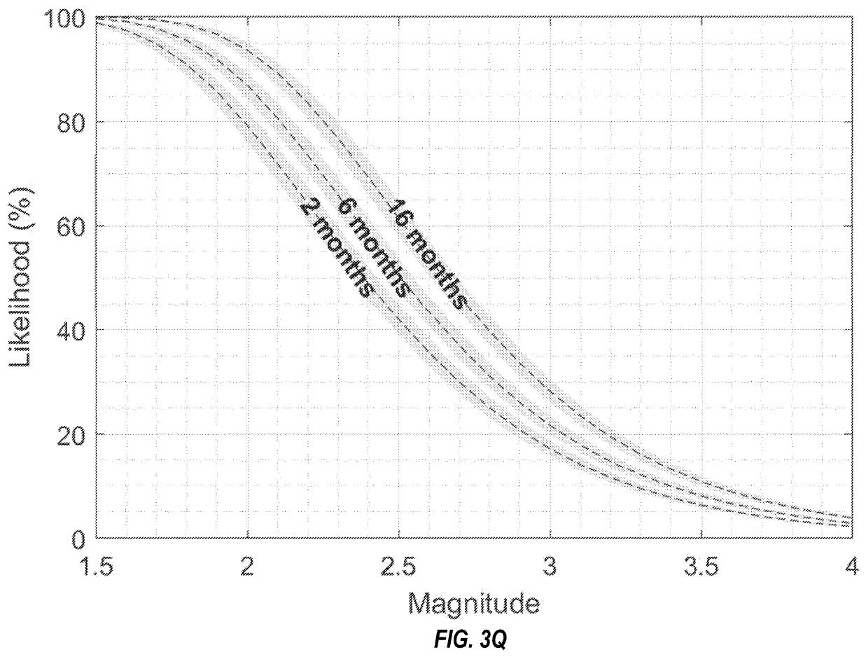

The historical event occurrence rate component 112 may be configured to history match a historical event occurrence rate for the processed dataset of induced seismic events using a correlation between the historical event occurrence rate and the Coulomb stress change to determine best fitting parameters. History matching may be performed for a time period (e.g., first 29 months in the synthetic example in FIGS. 3A-3Q). Convergence may be achieved by least square rule in the time domain. Best fit parameters and their associated uncertainties may be located by a Markov Chain Monte Carlo (MCMC) scheme.

If a constant magnitude of completeness is utilized, then history matching may utilize a complete set of events such that events above M_{c} may be selected.

If the location dependent magnitude of completeness is utilized, then history matching may be performed only for events above M_{c}(r). If a constant M_{c} is assumed for a case that M_{c}(r) has location dependency, it may lead to bias in event selection both temporally and spatially. As indicated by the synthetic example, a constant M_{c} discards many events near the receiver while adding events that are far away from the receiver that are below the true magnitude of completeness. Thus, history matching only for events above M_{c}(r) may improve accuracy of the workflow.

The following equations may be utilized for history matching:

$$\frac{R ( t )}{r} = \frac{exp ( \frac{Δ S ( t ) - Δ {S}_{c}}{A {σ}_{0}} )}{1 + \frac{1}{{t}_{a}} {\int }_{{t}_{b}}^{t} exp ( \frac{Δ S ( {t}^{′} ) - Δ {S}_{c}}{A {σ}_{0}} ) {dt}^{′}} if t \geq {t}_{b}$$

$$\frac{R}{r} = 0 if t < {t}_{b}$$

$${t}_{a} = \frac{A {σ}_{0}}{\dot{{s}_{b}}}$$

wherein ΔS_{c} refers to critical Coulomb stress threshold required to drive a fault toward instability, ΔS(t) refers to Coulomb stress change, tₐ refers to the time required to return to steady-state, t_{b} refers to the time at which the Coulomb stress exceeded the critical threshold, t refers to time, dt refers to infinitesimal time increment, R(t) refers to seismicity rate at time t, r refers background seismicity rate (e.g. seismicity rate at t=0), A refers to rate and state dependent friction parameter describing the amount of friction change due to slip velocity change, σ₀ refers to initial effective normal stress at t=0, and s_{b} refers to background shear stressing rate.

The potential future event occurrence rate component 114 may be configured to forecast a potential future event occurrence rate for induced seismic events above the magnitude of completeness based on at least one operational plan using the best fitting parameters. An “operational plan” refers to possible scenarios for injection or extraction of fluids of any types. The injection or extraction may involve a plurality of wells and may last for a different plurality of days. The injection or extraction rate may be constant or varying. An operational plan may be provided by a user as input. In some embodiments, an operational plan that is substantially the same as the operational plan corresponding to the dataset of induced seismic events may be utilized to forecast the potential future event occurrence rate. In some embodiments, an operational plan that is different than the original operational plan corresponding to the dataset of induced seismic events may be utilized to forecast the potential future event occurrence rate. A geomechanical model may be generated using future plans for fluid injection or extraction, physical properties of the subsurface, and geometry of existing fault planes. The geomechanical model may be a mechanical earth model (MEM) with different levels of complexity (e.g., analytical solutions, one-way couple, two-way couple). The pressure and Coulomb stress changes due to future operations may be calculated from the geomechanical model. The potential future event occurrence rate may be forecasted from the Coulomb stress change using the best fitted parameters from history matching.

The location penalty matrix component 115 may be configured to build a location penalty matrix to describe location dependent detection bias. The location penalty matrix may be created to document the bias of occurrence rate of induced seismic events due to location dependent detection bias. If a constant magnitude of completeness is utilized, the location penalty matrix becomes a constant value of one. If a location dependent magnitude of completeness is utilized, the location penalty matrix takes the form:

$$F ( r ) = 1 {0}^{b ( {M}_{c} ( r ) - {min}_{r} {M}_{c} ( r ) )}$$

wherein F(r) refers to the location penalty matrix, r refers to distance to the receiver, b refers to the Gutenberg-Richter b-value, M_{c}(r) refers to location dependent magnitude of completeness, and

$${min}_{r} {M}_{c} ( r )$$

refers to minimum magnitude of completeness over the entire subsurface of interest.

The potential future event occurrence rate update component 116 may be configured to, optionally, update the potential future event occurrence rate to include events larger than the smallest magnitude of completeness in response to utilizing location dependent magnitude of completeness. Matching/forecasting with location dependent magnitude of completeness may correct the detection bias that may occur in real event catalogs. However, a varying magnitude of completeness may lead to many events being undetected, which may in turn introduce inaccuracy in forecasting future risk levels because of under detection. If the location dependent magnitude of completeness is utilized, then this additional forecasting step may be performed to update the potential future event occurrence rate to account for the location dependent detection sensitivity. Events that are smaller than the location dependent magnitude of completeness M_{c}(r), but larger than the smallest magnitude of completeness in the subsurface

$${min}_{r} {M}_{c} ( r )$$

may be added by multiplying the occurrence rate with the location penalty matrix F(r) calculated previously. Furthermore, seismic events that may be indirectly induced from the subsurface operations in the form of aftershocks may be accounted for using the aftershocks productivity constrained from the declustering algorithm employed in the filtering component 106.

The estimated occurrence probability of potential future induced seismic events of different magnitudes component 118 may be configured to determine an estimated occurrence probability of future induced seismic events of different magnitudes based on the forecasted potential future event occurrence, the Gutenberg-Richter b-value, and the uncertainty range for the Gutenberg-Richter b-value. To determine the occurrence probabilities, some embodiments may start with Gutenberg-Richter law:

N[mᵢ>m]=10^{a-bm}

wherein N[mᵢ>m] refers to cumulative number of seismic events with magnitudes larger than m, b refers to the Gutenberg-Richter b-value, and a is some constant related to the productivity of seismic sequences. For any given time t in the future, some embodiments may use the potential future event occurrence rate of induced seismic events to determine the constant a of the Gutenberg-Richter law. Afterwards, for a given magnitude m, the following equation may be utilized to calculate occurrence probability based on Poisson likelihood:

[symbol]

[mᵢ>m,t]=1−exp(−N[mᵢ>m,t])

wherein [symbol] [mᵢ>m, t] refers to probability of induced seismic events larger than some magnitude m occurring by the time t in the future, and N[mᵢ>m, t] refers to the expected number of induced seismic events larger than some magnitude m occurring by the time t.

The representation component 120 may be configured to generate a representation of the estimated occurrence probability of potential future induced seismic events of different magnitudes. The representation may be generated using visual effects to depict at least a portion of the estimated occurrence probability of potential future induced seismic events of different magnitudes. This may be accomplished by a physical computer processor. In some embodiments, a visual effect may include a visual transformation of the representation. A visual transformation may include a visual change in how the representation is presented or displayed. In some embodiments, a visual transformation may include one of a visual zoom, a visual filter, a visual rotation, and/or a visual overlay (e.g., text and/or graphics overlay). The visual effect may include using a map (e.g., temperature map), or other color coding, to indicate the estimated occurrence probability of potential future induced seismic events of different magnitudes. In some implementations, the representation component 120 may be configured to display the representation. The representation may be displayed on a graphical user interface and/or other displays.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

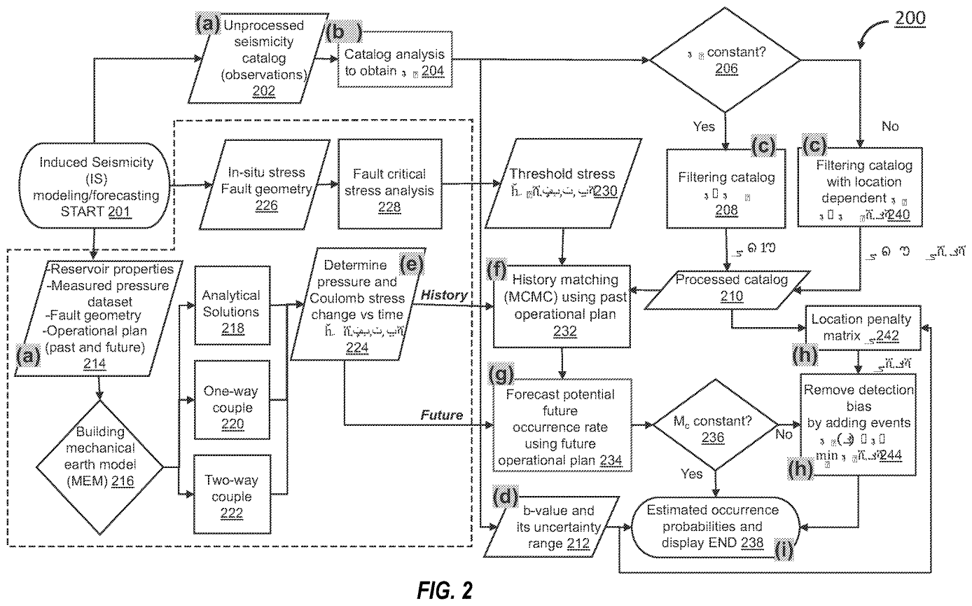

FIG. 2 illustrates a method 200 of induced seismicity forecasting, in accordance with some embodiments. The steps of method 200 presented below are intended to be illustrative. In some embodiments, the method 200 may be accomplished with an additional step not described and/or without one of the steps discussed. For example, if a constant magnitude of completeness is utilized in a particular implementation, then the items(s) related to a location dependent magnitude of completeness may be omitted in the particular implementation. As another example, if a location dependent magnitude of completeness is utilized in a particular implementation, then the item(s) related to a constant magnitude of completeness may be omitted in the particular implementation.

Additionally, the order in which the steps of method 200 is illustrated in FIG. 2 and described below is not intended to be limiting. In some methods, the method 200 may be implemented in a processing device (e.g., a digital processor, a physical computer processor, an analog processor, a digital circuit designed to process information, an analog circuit designed to process information, a state machine, and/or other mechanisms for electronically processing information). The processing device may include a device executing some or all of the operations of the method 200 in response to instructions stored electronically on an electronic storage medium. The processing device may include a device configured through hardware, firmware, and/or software to be specifically designed for execution of one of the steps of the method 200.

Turning to the method 200, item 201 may be the start of the method 200. Item 202 may include obtaining a dataset of induced seismic events for a subsurface volume of interest comprising at least one fault. An unprocessed seismicity catalog from observations from at least one receiver may be obtained. Item 202 may be performed by a physical computer processor configured by machine-readable instructions including a component that is the same as or similar to the data component 102, in accordance with one or more implementations.

Item 204 may include determining a magnitude of completeness for the subsurface volume of interest. The magnitude of completeness may be determined by analyzing the unprocessed seismicity catalog. The magnitude of completeness may be constant or location dependent. Item 204 may be performed by a physical computer processor configured by machine-readable instructions including a component that is the same as or similar to the magnitude of completeness component 104, in accordance with one or more implementations.

Item 206 may include determining if the method 200 is proceeding with a constant magnitude of completeness. If the answer is yes, the method 200 proceeds to item 208 to filter the unprocessed seismicity catalog using the determined constant magnitude of completeness to form a processed catalog as in item 210. Items 208-210 may be performed by a physical computer processor configured by machine-readable instructions including a component that is the same as or similar to the filtering component 106, in accordance with one or more implementations.

Item 212 may include determining a Gutenberg-Richter b-value and an uncertainty range for the Gutenberg-Richter b value for the dataset of induced seismic events. The Gutenberg-Richter b-value and the uncertainty range for the Gutenberg-Richter b value may be determined for the unprocessed seismicity catalog. Item 212 may be performed by a physical computer processor configured by machine-readable instructions including a component that is the same as or similar to the Gutenberg-Richter b value and uncertainty range component 108, in accordance with one or more implementations.

Items 214-230 may include building a geomechanical model of the subsurface volume of interest by history matching the measured pressure dataset to determine pressure for each fault and Coulomb stress change for each fault. The Coulomb stress change of each fault is based on the corresponding determined pressure of each fault. Building the geomechanical model further includes utilizing the obtained reservoir properties and the fault geometry. Items 214-230 may be performed by a physical computer processor configured by machine-readable instructions including a component that is the same as or similar to the pressure and Coulomb stress component 110 and/or the data component 102, in accordance with one or more implementations.

Item 232 may include history matching a historical event occurrence rate for the processed dataset of induced seismic events using the historical operational plan and a correlation between the historical event occurrence rate and the Coulomb stress change of each fault to determine best fitting parameters. Item 232 may be performed by a physical computer processor configured by machine-readable instructions including a component that is the same as or similar to the historical event occurrence rate component 112, in accordance with one or more implementations.

Item 234 may include forecasting a potential future event occurrence rate for induced seismic events above the constant magnitude of completeness based on the future operational plan using the best fitting parameters. Item 234 may be performed by a physical computer processor configured by machine-readable instructions including a component that is the same as or similar to the potential future event occurrence rate component 114, in accordance with one or more implementations.

Item 236 may include determining if the method 200 is proceeding with a constant magnitude of completeness. If the answer is yes, the method 200 proceeds to item 238. Item 238 may include determining an estimated occurrence probability of potential future induced seismic events of different magnitudes based on the forecasted potential future event occurrence rate, the Gutenberg-Richter b value, and the uncertainty range for the Gutenberg-Richter b value. Item 238 may be performed by a physical computer processor configured by machine-readable instructions including a component that is the same as or similar to the estimated occurrence probability of potential future induced seismic events of different magnitudes component 118, in accordance with one or more implementations.

Item 238 may also include generating a representation of the estimated occurrence probability of potential future induced seismic events of different magnitudes and displaying the representation in a graphical user interface. Item 238 may be performed by a physical computer processor configured by machine-readable instructions including a component that is the same as or similar to the representation component 120, in accordance with one or more implementations.

For the constant magnitude of completeness, items 201-238 may be utilized from FIG. 2 as described above. For the location dependent magnitude of completeness, items 201-238, except item 208, may be utilized from FIG. 2. Moreover, for the location dependent magnitude of completeness, items 240, 242, and 244 may be additionally utilized from FIG. 2 as explained below.

Returning to item 206, item 206 may include determining if the method 200 is proceeding with a constant magnitude of completeness. If the answer is no, and the location dependent magnitude of completeness was determined, the method 200 proceeds to item 240 to filter the unprocessed seismicity catalog using the location dependent magnitude of completeness to form a processed catalog as in item 210. As previously described, item 240 may be performed by a physical computer processor configured by machine-readable instructions including a component that is the same as or similar to the filtering component 106, in accordance with one or more implementations.

Returning to item 236, item 236 may include determining if the method 200 is proceeding with a constant magnitude of completeness. If the answer is no, and the location dependent magnitude of completeness was determined, the method 200 proceeds to items 242 and 244. Item 242 may include building a location penalty matrix to describe location dependent detection bias in response to utilizing location dependent magnitude of completeness. The Gutenberg-Richter b-value and the uncertainty range for the Gutenberg-Richter b value from item 212 may be utilized to build the location penalty matrix. Item 242 may be performed by a physical computer processor configured by machine-readable instructions including a component that is the same as or similar to the location penalty matrix component 115, in accordance with one or more implementations. Item 244 may include updating the potential future event occurrence rate to include events larger than the smallest magnitude of completeness in response to utilizing location dependent magnitude of completeness. Item 244 may be performed by a physical computer processor configured by machine-readable instructions including a component that is the same as or similar to the potential future event occurrence rate update component 116, in accordance with one or more implementations.

FIGS. 3A-3Q illustrate a synthetic example to facilitate understanding of the various steps. The synthetic example includes various assumptions, such as, but not limited to, the existence of three faults, the existence of two injection wells (also known as injectors), and the existence of one seismic sensor (also referred to as a seismic receiver or simply receiver) such as a geophone or other seismic sensor. Those of skill in the art will appreciate that the synthetic example is not meant to be limiting.

Turning to the synthetic example, FIG. 3A illustrates an example model of an induced seismicity setup. In this 2D model, there are 3 faults, 2 injectors, and 1 receiver. Water of volume 5×10⁵ m³ was instantaneously injected into injector number 1 and 2, at t=1 month and t=29 months, respectively.

In FIG. 3B, using the example model of induced seismicity setup in FIG. 3A, the detection limits of the induced seismic events vary with the distance from the receiver. For an example, the detection limits M_{d} may decay with distance from the receiver r in the following forms: M_{d}=1.25 logr−6.16.

In FIG. 3C, using the example model of induced seismicity setup in FIG. 3A, a synthetic catalog of induced seismic events driven by water injection may be generated assuming a Gutenberg-Richter b-value of 0.95. Events with magnitude M>M_{c} were assumed to be detected by the receiver. Events with magnitude M<M_{d} were assumed not to be detected by the receiver. Events with magnitude M_{d}≤M≤M_{c} were detected with probability (M−M_{d})/(M_{c}−M_{d}). The detection limits Ma may decay with distance from the receiver r in the following forms: M_{d}=1.25 logr−6.16. The completeness magnitude M_{c} may decay with distance from the receiver r in the following forms: M_{c}=1.25 logr−5.66.

In FIG. 3D, using the example synthetic induced seismic events in FIG. 3C, a histogram of event magnitudes may be created. A magnitude of completeness M_{c}, assumed to be a constant, may be calculated using the magnitude at which the non-cumulative events count is at maximum, shown as a vertical dashed line (step b and d in FIG. 2). The slope of the cumulative number of events larger than a given magnitude is the Gutenberg-Richter b-value b, which may be calculated using the maximum likelihood estimate. The 95% confidence interval of magnitude distribution may be simulated using the determined M_{c} and b, an example of which is shown as a shaded region.

In FIG. 3E, using the example synthetic induced seismic events in FIG. 3C, a scatter plot showing magnitude vs. distance to the receiver may be generated. This graphic illustrates that for an example model of induced seismicity setup in FIG. 3A with a single receiver, filtering induced seismic events (step c in FIG. 2) using a constant magnitude of completeness M_{c} may lead to bias such that too many events near the receiver are removed while too many additional events far from the receiver are included.

In FIG. 3F, using the example synthetic induced seismic events in FIG. 3C, a location dependent magnitude of completeness M_{c}(r) may be estimated from the data (step b in FIG. 2). Events may be binned based on distance to receiver r. For each bin, M_{c} may be calculated using maximum non-cumulative events count shown as filled black circles. These values of M_{c}(r) may then be fitted using an assumed analytical form such as a logarithmic function.

In FIG. 3G, using the example model of induced seismicity setup in FIG. 3A, fluid pore pressure change caused by the injection may be computed at different time steps using a mechanical earth model (MEM) with different levels of complexity (step e in FIG. 2). In this example, an analytical solution assuming isotropic medium with constant hydraulic diffusivity was used.

In FIG. 3H, using the example model of induced seismicity setup in FIG. 3A, a Mohr-Coulomb failure envelope may be generated. The in-situ maximum horizontal compressional stress Sₕₘₐₓ was assumed to be 23 MPa, minimum horizontal compressional stress Sₕₘᵢₙ to be 13.3 MPa, vertical compressional stress Sᵥ to be 20 MPa, and fluid pore pressure P to be 8.8 MPa. The orientation was selected such that fault number 2 has the most favorable orientation for failure with smallest critical Coulomb stress threshold ΔS_{c}.

In FIG. 3I, using the example model of induced seismicity setup in FIG. 3A, spatial and temporal evolution of Coulomb stress change ΔS on each fault plane may be calculated (step e in FIG. 2). For each fault increment, the temporal evolution of Coulomb stress change is plotted.

In FIG. 3J, using the example model of induced seismicity setup in FIG. 3A and the example synthetic induced seismic events in FIG. 3C, a history matching using a theoretical model of seismicity driven by Coulomb stress change ΔS in FIG. 3I may be performed for events above a magnitude of completeness M_{c}(r) using a Markov Chain Monte Carlo (MCMC) scheme (step f in FIG. 2). The fitted parameters shown here include the rate and state dependent friction parameter A, the background shear stressing rate BCrate, and a scaling factor of ΔS_{c} which accounts for variable static friction coefficient. History matching uses only the synthetic induced seismic events during first 29 months. The latter 16 months of data are assumed to be in the future and reserved for testing the performances of the proposed forecasting method.

In FIG. 3K, a comparison is illustrated of temporal matching between the data (vertical bars) and the model (black lines) with the best fitted parameters from FIG. 3J.

In FIG. 3L, a comparison is illustrated of spatial matching between the data (left) and the model (middle) with the best fitted MCMC parameters from FIG. 3J. The residuals (right) between the data and the model may also be calculated.

In FIG. 3M, using the best fitted parameters from history matching (FIG. 3J), induced seismicity forecasting may be performed for events above a magnitude of completeness M_{c}(r) (step g in FIG. 2). The prediction of future monthly seismicity rate and cumulative number of seismic events (black lines) may be compared with the data (vertical bars).

In FIG. 3N, using the best fitted parameters from history matching (FIG. 3J), induced seismicity forecasting may be performed for events above a magnitude of completeness M_{c}(r) (step g in FIG. 2). The forecasted spatial distribution of future number of induced seismic events is shown.

In FIG. 3O, for the scenario in which the detection sensitivity is location dependent such as in the synthetic example in FIG. 3C, the detection bias is removed by updating the forecasted future occurrence rate to include events smaller than M_{c}(r) but larger than the smallest magnitude of completeness

$${min}_{r} {M}_{c} ( r ) = - 2$$

(step n in FIG. 2).

In FIG. 3P, the updated forecasted future occurrence accounting for detection bias may be compared with the complete synthetic catalog in FIG. 3C with constant magnitude of completeness

$${M}_{c} = {min}_{r} {M}_{c} ( r ) = - 2 .$$

The forecasted future occurrence is now in a better agreement with the data than in the case where detection bias is not accounted for (FIG. 3M).

In FIG. 3Q, the occurrence probability of future induced seismic events of different magnitudes based on the Poissonian likelihood may be calculated for a given operational plan such as the example plan in FIG. 3A (step i in FIG. 2). FIG. 3Q may be displayed on a computer system to a user.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Terminology: The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subsurface volume of interest” refers to practically any volume under a surface. For example, it may be practically any volume under a terrestrial surface (e.g., a land surface), practically any volume under a seafloor, etc. The subsurface volume of interest may be divided into one or more zones. The subsurface volume of interest may include resources such as hydrocarbons, a rock matrix, and geological features. The hydrocarbons may be liquid hydrocarbons (also known as oil or petroleum), gas hydrocarbons (e.g., natural gas), solid hydrocarbons (e.g., asphaltenes or waxes), a combination of hydrocarbons (e.g., a combination of liquid hydrocarbons, gas hydrocarbons, and solid hydrocarbons), etc. The hydrocarbons may be discovered by hydrocarbon exploration processes.

Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to: shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subsurface volume of interest” is not limited to any description or configuration described herein.

A “well” refers to a single hole, usually cylindrical, that is drilled into a subsurface volume of interest. A well may be drilled in one or more directions. For example, a well may include a vertical well, a horizontal well, a deviated well, and/or other type of well. A well may be drilled in the subsurface volume of interest for exploration and/or recovery of resources. For example, a well may be drilled in the subsurface volume of interest to aid in extraction and/or production of resources such as hydrocarbons. As another example, a well may be drilled in the subsurface volume of interest for fluid injection. A plurality of wells (e.g., tens to hundreds of wells) are often used in a field depending on the desired outcome.

A well may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well may be installed according to the design of the well. The equipment to be used in drilling the well may be dependent on the design of the well, the subsurface volume of interest, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

A well may be utilized to recover hydrocarbons (sometimes referred to as produced) from a subsurface volume of interest using natural reservoir energy, water injection (also referred to as waterflooding), gas injection, enhanced oil recovery (EOR), fracturing, etc. Enhanced oil recovery refers to techniques for increasing the amount of hydrocarbons that may be extracted from the subsurface volume of interest, such as, but not limited to, chemical injection (sometimes referred to as chemical enhanced oil recovery (CEOR) or thermal recovery (which includes, for example, cyclic steam and steam flooding). A fracturing process may include fracturing using electrodes, fracturing using fluid injection (oftentimes referred to as hydraulic fracturing), etc. Other hydrocarbon recovery processes may also be utilized to recover the hydrocarbons. A well may be utilized for other purposes. For example, a well may be utilized as a disposal well.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

References: The following references are each incorporated by reference:
Aki, K. (1965), Maximum likelihood estimate of b in the formula log N=a−bm and its confidence limits, Bulletin of the Earthquake Research Institute, University of Tokyo, 43, 237-238.
Barbour, A. J., Norbeck J. H. and Rubinstein, J. L. (2017), The Effects of Varying Injection Rates in Osage County, Oklahoma, on the 2016 Mw 5.8 Pawnee Earthquake, Seismological Research Letters, 88, 1040-1053, doi: 10.1785/0220170003.
Candela, T., Osinga, S., Ampuero, J.-P., Wassing, B., Pluymaekers, M., Fokker, P. A., van Wees, J.-D., de Waal, H. A. and Muntendam-Bos, A. G. (2019). Depletion-induced seismicity at the Groningen gas field: Coulomb rate-and-state models including differential compaction effect, Journal of Geophysical Research: Solid Earth, 124, 7081-7104, doi: 10.1029/2018JB016670
Dieterich, J. H. (1979), Modeling of rock friction: 1. Experimental results and constitutive equations, Journal of Geophysical Research, 84 (B5), 2161-2168, doi: 10.1029/JB084iB05p02161.
Dieterich, J. (1994), A constitutive law for rate of earthquake production and its application to earthquake clustering, Journal of Geophysical Research., 99 (B2), 2601-2618, doi: 10.1029/93JB02581.
Hainzl, S., Steacy, S. and Marsan D. (2010), Seismicity models based on Coulomb stress calculations, Community Online Resources for Statisical Seismicity Analysis. Available at http://www.corssa.org.
Eaton, D. W. and Maghsoudi, S. (2015), 2b or not 2b? Interpreting magnitude distributions from microseismic catalogs, first break, 33.
Heimisson, E. R. and Smith, J. D. and Avouac, J.-P., and Bourne, S. J. (2022), Coulomb threshold rate-and-state model for fault reactivation: application to induced seismicity at Groningen. Geophysical Journal International, 228 (3), 2061-2072, doi: 10.1093/gji/ggab467.
Hennings, P. H., Lund See, J.-E., Osmond, J. L., DeShon, H. R., Dommisse, R., Horne, E., Lemons, C. and Zoback, M. D. (2019), Injection-Induced Seismicity and Fault-Slip Potential in the Fort Worth Basin, Texas. Bulletin of the Seismological Society of America, 109 (5), 1615-1634, doi: 10.1785/0120190017.
Kijko, A. and Smit A. (2012), Extension of the Aki-Utsu b-value estimator for incomplete catalogs, Bulletin of the Seismological Socieyt of America, 102 (3), 1283-1287, doi: 10.1785/0120110226.
Mignan, A. and Woessner, J. (2012), Estimating the magnitude of completeness for earthquake catalogs, Community Online Resource for Statistical Seismicity Analysis, doi: 10.5078/corssa-001808805. Available at http://www.corssa.org.
Rice, J. R. and A. L. Ruina (1983), Stability of steady frictional slipping, Journal of Applied Mechanics, 50, 343-349, doi: 10.1115/1.3167042.
Richter, G., Hainzl, S., and Dahm, T. (2020), Stress-based, statistical modeling of the induced seismicity at the Groningen gas field, The Netherlands. Environ. Earth. Sci. 79, 252, doi: 10.1007/s12665-020-08941-4.
Rollins, C. and Avouac, J.-P. (2019), A geodesy- and seismicity-based local earthquake likelihood model for central Los Angeles, Geophysical Research Letters, 46 (6), doi: 10.1029/2018GL080868.
Segall, P. and Lu, S. (2015), Injection-induced seismicity: Poroelastic and earthquake nucleation effects, Journal of Geophysical Research: Solid Earth, 120, 5082-5103, doi: 10.1002/2015JB012060.
Ground Water Protection Council and Interstate Oil and Gas Compact Commission. Potential Injection-Induced Seismicity Associated with Oil & Gas Development: A Primer on Technical and Regulatory Considerations Informing Risk Management and Mitigation. Second Edition, 2017; ISWG_Primer Second Edition_Final_11_17_2017.pdf (gwpc.org)
Smith, J. D., Heimisson, E. R., Bourne, S. J. and Avouac, J.-P. (2022). Stress-based forecasting of induced seismicity with instantaneous earthquake failure functions: Applications to the Groningen gas reservoir, Earth and Planetary Sciene Letters, 594, 117697, doi: 10.1016/j.epsl.2022.117697.
Skoumal, R. J., Barbour, A. J., Brudzinski, M. R., Langenkamp, T. and Kaven, J. O. (2020). Induced seismicity in the Delaware Basin, Texas, Journal of Geophysical Research: Solid Earth, 125, e2019JB018558.doi: 10.1029/2019JB018558
Van Stiphout, T., Zhuang, J. and Marsan, D. (2012), Seismicity declustering, Community Online Resource for Statistical Seismicity Analysis. Available at http://www.corssa.org.
Zhai, G., Shirzaei, M., Manga M. and Chen X. (2019), Pore-pressure diffusion, enhanced by poroelastic stresses, controls induced seismicity in Oklahoma, Proceedings of the National Academy of Sciences, 116 (33), 16228-16233, doi: 10.1073/pnas.1819225116.

What is claimed is:

1. A computer-implemented method of induced seismicity forecasting, the method comprising:
(a) obtaining a dataset of induced seismic events, reservoir properties, fault geometry, a measured pressure dataset, a historical operational plan, and a future operation plan for a subsurface volume of interest comprising at least one fault;
(b) determining a magnitude of completeness for the subsurface volume of interest from the dataset obtained in the step (a), wherein the magnitude of completeness is a constant magnitude of completeness;
(c) filtering the dataset of induced seismic events using the determined constant magnitude of completeness from the step (b) to form a processed dataset of induced seismic events;
(d) determining a Gutenberg-Richter b-value and an uncertainty range for the Gutenberg-Richter b value for the subsurface volume of interest for the dataset of induced seismic events from the step (a);
(e) building a geomechanical model of the subsurface volume of interest by history matching the measured pressure dataset from the step (a) to determine pressure for each fault and Coulomb stress change for each fault, wherein the Coulomb stress change of each fault is based on the corresponding determined pressure of each fault, and wherein building the geomechanical model further includes utilizing the obtained reservoir properties from the step (a) and the fault geometry from the step (a);
(f) history matching a historical event occurrence rate for the processed dataset of induced seismic events from the step (c) using the historical operational plan from the step (a) and a correlation between the historical event occurrence rate and the Coulomb stress change of each fault from the step (e) to determine best fitting parameters;
(g) forecasting a potential future event occurrence rate for induced seismic events above the constant magnitude of completeness from the step (b) based on the future operational plan from the step (a) using the best fitting parameters from the step (f); and
(i) determining an estimated occurrence probability of potential future induced seismic events of different magnitudes based on the forecasted potential future event occurrence rate from the step (g), the Gutenberg-Richter b value from the step (d), and the uncertainty range for the Gutenberg-Richter b value from the step (d).

2. The method of claim 1, further comprising: generating a representation of the estimated occurrence probability of potential future induced seismic events of different magnitudes and displaying the representation in a graphical user interface.

3. The method of claim 1, wherein the uncertainty range for the Gutenberg-Richter b-value is determined using a Markov Chain Monte Carlo (MCMC) scheme or a bootstrap approach.

4. The method of claim 1, wherein the step (f) of history matching includes utilizing an equation:
$$\frac{R ( t )}{r} = \frac{exp ( \frac{Δ S ( t ) - Δ {S}_{c}}{A {σ}_{0}} )}{1 + \frac{1}{{t}_{a}} {\int }_{{t}_{b}}^{t} exp ( \frac{Δ S ( {t}^{′} ) - Δ {S}_{c}}{A {σ}_{0}} ) {dt}^{′}} if t \geq {t}_{b}$$
$$\frac{R}{r} = 0 if t < {t}_{b}$$
$${t}_{a} = \frac{A {σ}_{0}}{\dot{{s}_{b}}}$$
wherein ΔS_{c} refers to critical Coulomb stress threshold required to drive a fault toward instability, ΔS(t) refers to Coulomb stress change, tₐ refers to time required to return to steady-state, t_{b} refers to time at which Coulomb stress exceeded critical threshold, t refers to time, dt refers to infinitesimal time increment, R(t) refers to seismicity rate at time t, r refers background seismicity rate, A refers to rate and state dependent friction parameter describing amount of friction change due to slip velocity change, σ₀ refers to initial effective normal stress at t=0, and s_{b} refers to background shear stressing rate.

5. The method of claim 1, wherein the estimated occurrence probability of potential future induced seismic events of different magnitudes is determined based on Poisson likelihood: [symbol]
[mᵢ>m,t]=1−exp(−N[mᵢ>m,t])
wherein [symbol] [mᵢ>m, t] refers to probability of induced seismic events larger than some magnitude m occurring by time t in future, and N[mᵢ>m, t] refers to expected number of induced seismic events larger than some magnitude m occurring by time t.

6. A computer system, comprising:
one or more processors;
memory; and
one or more programs, wherein the one or more programs are stored in the memory and configured to be executed by the one or more processors, the one or more programs including instructions that when executed by the one or more processors cause the system to perform a method of induced seismicity forecasting, the method comprising:
(a) obtaining a dataset of induced seismic events, reservoir properties, fault geometry, a measured pressure dataset, a historical operational plan, and a future operation plan for a subsurface volume of interest comprising at least one fault;
(b) determining a magnitude of completeness for the subsurface volume of interest from the dataset obtained in the step (a), wherein the magnitude of completeness is a constant magnitude of completeness;
(c) filtering the dataset of induced seismic events using the determined constant magnitude of completeness from the step (b) to form a processed dataset of induced seismic events;
(d) determining a Gutenberg-Richter b-value and an uncertainty range for the Gutenberg-Richter b value for the subsurface volume of interest for the dataset of induced seismic events from the step (a);
(e) building a geomechanical model of the subsurface volume of interest by history matching the measured pressure dataset from the step (a) to determine pressure for each fault and Coulomb stress change for each fault, wherein the Coulomb stress change of each fault is based on the corresponding determined pressure of each fault, and wherein building the geomechanical model further includes utilizing the obtained reservoir properties from the step (a) and the fault geometry from the step (a);
(f) history matching a historical event occurrence rate for the processed dataset of induced seismic events from the step (c) using the historical operational plan from the step (a) and a correlation between the historical event occurrence rate and the Coulomb stress change of each fault from the step (e) to determine best fitting parameters;
(g) forecasting a potential future event occurrence rate for induced seismic events above the constant magnitude of completeness from the step (b) based on the future operational plan from the step (a) using the best fitting parameters from the step (f); and
(i) determining an estimated occurrence probability of potential future induced seismic events of different magnitudes based on the forecasted potential future event occurrence rate from the step (g), the Gutenberg-Richter b value from the step (d), and the uncertainty range for the Gutenberg-Richter b value from the step (d).

7. The system of claim 6, wherein the one or more programs include instructions that when executed by the one or more processors cause the system to generate a representation of the estimated occurrence probability of potential future induced seismic events of different magnitudes and display the representation in a graphical user interface.

8. The system of claim 6, wherein the uncertainty range for the Gutenberg-Richter b-value is determined using a Markov Chain Monte Carlo (MCMC) scheme or a bootstrap approach.

9. The system of claim 6, wherein the step (f) of history matching includes utilizing an equation:
$$\frac{R ( t )}{r} = \frac{exp ( \frac{Δ S ( t ) - Δ {S}_{c}}{A {σ}_{0}} )}{1 + \frac{1}{{t}_{a}} {\int }_{{t}_{b}}^{t} exp ( \frac{Δ S ( {t}^{′} ) - Δ {S}_{c}}{A {σ}_{0}} ) {dt}^{′}} if t \geq {t}_{b}$$
$$\frac{R}{r} = 0 if t < {t}_{b}$$
$${t}_{a} = \frac{A {σ}_{0}}{\dot{{s}_{b}}}$$
wherein ΔS_{c} refers to critical Coulomb stress threshold required to drive a fault toward instability, ΔS(t) refers to Coulomb stress change, tₐ refers to time required to return to steady-state, t_{b} refers to time at which Coulomb stress exceeded critical threshold, t refers to time, dt refers to infinitesimal time increment, R(t) refers to seismicity rate at time t, r refers background seismicity rate, A refers to rate and state dependent friction parameter describing amount of friction change due to slip velocity change, σ₀ refers to initial effective normal stress at t=0, and s_{b} refers to background shear stressing rate.

10. The system of claim 6, wherein the estimated occurrence probability of potential future induced seismic events of different magnitudes is determined based on Poisson likelihood: [symbol]
[mᵢ>m,t]=1−exp(−N[mᵢ>m,t])
wherein [symbol] [mᵢ>m, t] refers to probability of induced seismic events larger than some magnitude m occurring by time t in future, and N[mᵢ>m, t] refers to expected number of induced seismic events larger than some magnitude m occurring by time t.

11. A computer-implemented method of induced seismicity forecasting, the method comprising:
(a) obtaining a dataset of induced seismic events, reservoir properties, fault geometry, a measured pressure dataset, a historical operational plan, and a future operation plan for a subsurface volume of interest comprising at least one fault;
(b) determining a magnitude of completeness for the subsurface volume of interest from the dataset obtained in the step (a), wherein the magnitude of completeness is a location dependent magnitude of completeness;
(c) filtering the dataset of induced seismic events using the determined location dependent magnitude of completeness from the step (b) to form a processed dataset of induced seismic events;
(d) determining a Gutenberg-Richter b-value and an uncertainty range for the Gutenberg-Richter b value for the subsurface volume of interest for the dataset of induced seismic events from the step (a);
(e) building a geomechanical model of the subsurface volume of interest by history matching the measured pressure dataset from the step (a) to determine pressure for each fault and Coulomb stress change for each fault, wherein the Coulomb stress change of each fault is based on the corresponding determined pressure of each fault, and wherein building the geomechanical model further includes utilizing the obtained reservoir properties from the step (a) and the fault geometry from the step (a);
(f) history matching a historical event occurrence rate for the processed dataset of induced seismic events from the step (c) using the historical operational plan from the step (a) and a correlation between the historical event occurrence rate and the Coulomb stress change of each fault from the step (e) to determine best fitting parameters;
(g) forecasting a potential future event occurrence rate for induced seismic events above the location dependent magnitude of completeness from the step (b) based on future operational plan from the step (a) using the best fitting parameters from the step (f);
(h) building a location penalty matrix to describe location dependent detection bias using the processed dataset of induced seismic events from the step (c) and the Gutenberg-Richter b value from the step (d), and updating the potential future event occurrence rate to include events larger than the smallest magnitude of completeness using the location penalty matrix; and
(i) determining an estimated probability of potential future induced seismic events of different magnitudes based on the forecasted potential future event occurrence rate from the step (h), the Gutenberg-Richter b value from the step (d), and the uncertainty range for the Gutenberg-Richter b value from step (d).

12. The method of claim 11, further comprising generating a representation of the estimated probability of potential future induced seismic events of different magnitudes and displaying the representation in a graphical user interface.

13. The method of claim 11, wherein the uncertainty range for the Gutenberg-Richter b-value is determined using a Markov Chain Monte Carlo (MCMC) scheme or a bootstrap approach.

14. The method of claim 11, wherein the step (f) of history matching includes utilizing an equation:
$$\frac{R ( t )}{r} = \frac{exp ( \frac{Δ S ( t ) - Δ {S}_{c}}{A {σ}_{0}} )}{1 + \frac{1}{{t}_{a}} {\int }_{{t}_{b}}^{t} exp ( \frac{Δ S ( {t}^{′} ) - Δ {S}_{c}}{A {σ}_{0}} ) {dt}^{′}} if t \geq {t}_{b}$$
$$\frac{R}{r} = 0 if t < {t}_{b}$$
$${t}_{a} = \frac{A {σ}_{0}}{\dot{{s}_{b}}}$$
wherein ΔS_{c} refers to critical Coulomb stress threshold required to drive a fault toward instability, ΔS(t) refers to Coulomb stress change, tₐ refers to time required to return to steady-state, t_{b} refers to time at which Coulomb stress exceeded critical threshold, t refers to time, dt refers to infinitesimal time increment, R(t) refers to seismicity rate at time t, r refers background seismicity rate, A refers to rate and state dependent friction parameter describing amount of friction change due to slip velocity change, σ₀ refers to initial effective normal stress at t=0, and s_{b} refers to background shear stressing rate.

15. The method of claim 11, wherein the estimated occurrence probability of potential future induced seismic events of different magnitudes is determined based on Poisson likelihood: [symbol]
[mᵢ>m,t]=1−exp(−N[mᵢ>m,t])
wherein [symbol] [mᵢ>m, t] refers to probability of induced seismic events larger than some magnitude m occurring by time t in future, and N[mᵢ>m, t] refers to expected number of induced seismic events larger than some magnitude m occurring by time t.

16. The method of claim 11, wherein the location penalty matrix is built utilizing an equation:
$$F ( r ) = 1 {0}^{b ( {M}_{c} ( r ) - {min}_{r} {M}_{c} ( r ) )}$$
wherein F(r) refers to the location penalty matrix, r refers to distance to receiver, b refers to Gutenberg-Richter b-value, M_{c}(r) refers to location dependent magnitude of completeness, and
$${min}_{r} {M}_{c} ( r )$$
refers to minimum magnitude of completeness over entire subsurface volume of interest.

17. A computer system, comprising:
one or more processors;
memory; and
one or more programs, wherein the one or more programs are stored in the memory and configured to be executed by the one or more processors, the one or more programs including instructions that when executed by the one or more processors cause the system to perform a method of induced seismicity forecasting, the method comprising:
(a) obtaining a dataset of induced seismic events, reservoir properties, fault geometry, a measured pressure dataset, a historical operational plan, and a future operation plan for a subsurface volume of interest comprising at least one fault;
(b) determining a magnitude of completeness for the subsurface volume of interest from the dataset obtained in the step (a), wherein the magnitude of completeness is a location dependent magnitude of completeness;
(c) filtering the dataset of induced seismic events using the determined location dependent magnitude of completeness from the step (b) to form a processed dataset of induced seismic events;
(d) determining a Gutenberg-Richter b-value and an uncertainty range for the Gutenberg-Richter b value for the subsurface volume of interest for the dataset of induced seismic events from the step (a);
(e) building a geomechanical model of the subsurface volume of interest by history matching the measured pressure dataset from the step (a) to determine pressure for each fault and Coulomb stress change for each fault, wherein the Coulomb stress change of each fault is based on the corresponding determined pressure of each fault, and wherein building the geomechanical model further includes utilizing the obtained reservoir properties from the step (a) and the fault geometry from the step (a);
(f) history matching a historical event occurrence rate for the processed dataset of induced seismic events from the step (c) using the historical operational plan from the step (a) and a correlation between the historical event occurrence rate and the Coulomb stress change of each fault from the step (e) to determine best fitting parameters;
(g) forecasting a potential future event occurrence rate for induced seismic events above the location dependent magnitude of completeness from the step (b) based on future operational plan from the step (a) using the best fitting parameters from the step (f);
(h) building a location penalty matrix to describe location dependent detection bias using the processed dataset of induced seismic events from the step (c) and the Gutenberg-Richter b value from the step (d), and updating the potential future event occurrence rate to include events larger than the smallest magnitude of completeness using the location penalty matrix; and
(i) determining an estimated probability of potential future induced seismic events of different magnitudes based on the forecasted potential future event occurrence rate from the step (h), the Gutenberg-Richter b value from the step (d), and the uncertainty range for the Gutenberg-Richter b value from step (d).

18. The system of claim 17, further comprising generating a representation of the estimated probability of potential future induced seismic events of different magnitudes and displaying the representation in a graphical user interface.

19. The system of claim 17, wherein the uncertainty range for the Gutenberg-Richter b-value is determined using a Markov Chain Monte Carlo (MCMC) scheme or a bootstrap approach.

20. The system of claim 17, wherein the step (f) of history matching includes utilizing an equation:
$$\frac{R ( t )}{r} = \frac{exp ( \frac{Δ S ( t ) - Δ {S}_{c}}{A {σ}_{0}} )}{1 + \frac{1}{{t}_{a}} {\int }_{{t}_{b}}^{t} exp ( \frac{Δ S ( {t}^{′} ) - Δ {S}_{c}}{A {σ}_{0}} ) {dt}^{′}} if t \geq {t}_{b}$$
$$\frac{R}{r} = 0 if t < {t}_{b}$$
$${t}_{a} = \frac{A {σ}_{0}}{\dot{{s}_{b}}}$$
wherein ΔS_{c} refers to critical Coulomb stress threshold required to drive a fault toward instability, ΔS(t) refers to Coulomb stress change, tₐ refers to time required to return to steady-state, t_{b} refers to time at which Coulomb stress exceeded critical threshold, t refers to time, dt refers to infinitesimal time increment, R(t) refers to seismicity rate at time t, r refers background seismicity rate, A refers to rate and state dependent friction parameter describing amount of friction change due to slip velocity change, σ₀ refers to initial effective normal stress at t=0, and s_{b} refers to background shear stressing rate.

21. The system of claim 17, wherein the estimated occurrence probability of potential future induced seismic events of different magnitudes is determined based on Poisson likelihood: [symbol]
[mᵢ>m,t]=1−exp(−N[mᵢ>m,t])
wherein [symbol] [mᵢ>m, t] refers to probability of induced seismic events larger than some magnitude m occurring by time t in future, and N[mᵢ>m, t] refers to expected number of induced seismic events larger than some magnitude m occurring by time t.

22. The system of claim 17, wherein the location penalty matrix is built utilizing an equation:
$$F ( r ) = 1 {0}^{b ( {M}_{c} ( r ) - {min}_{r} {M}_{c} ( r ) )}$$
wherein F(r) refers to the location penalty matrix, r refers to distance to receiver, b refers to Gutenberg-Richter b-value, M_{c}(r) refers to location dependent magnitude of completeness, and
$${min}_{r} {M}_{c} ( r )$$
refers to minimum magnitude of completeness over entire subsurface volume of interest.
